(19) United States
(12) Patent Application Publication
(10) Pub. No.: US 2026/0364821 A1
(43) Pub. Date: Nov. 19, 2026

(54) Robotic Tool Changer Having Tool Stand Driven Coupling Cam, Axial Compliance, and Passive Off-Tool Stand Locking

(71) Applicant: ATI Industrial Automation, Inc., Apex, NC (US)

(72) Inventor: Nathan Brace, Fuquay-Varina, NC (US)

(21) Appl. No.: 19/676,241

(22) Filed: May 13, 2026

Related U.S. Application Data
(60) Provisional application No. 63/806,066, filed on May 15, 2025.

(51) Int. Cl. B25J 15/04

(52) U.S. Cl. CPC B25J 15/0416; B25J 15/0425; B25J 15/0491

(57) ABSTRACT

A mechanically actuated robotic tool changer system comprises a master unit, a tool unit, and a tool stand. An annular cam ring in the tool unit moves ball members radially in or out—into or out of contact with mating features on the master unit—as the annular cam ring rotates between decoupled and coupled rotary positions. Pinion gear teeth on the circumference of the annular cam ring engage with rack gear teeth on the tool stand, so that linear motion of the tool unit into or out of the tool stand rotates the annular cam ring to couple or decouple the master and tool units. A detent pin locks the annular cam ring in the coupled rotary position when the tool unit is removed from the tool stand. An arm of the tool stand engages an engagement pin to retract the detent pin, unlocking the annular cam ring.

### RELATED APPLICATIONS

This application claims the benefit of U.S. Provisional Application No. 63/806066, filed May 15, 2025, the entire disclosure of which being hereby incorporated by reference herein.

### FIELD OF DISCLOSURE

The present disclosure relates generally to robotic tool changers, and in particular to a robotic tool changer having a locking cam driven between coupling and decoupling positions by movement out of and into a mating tool stand, the locking cam having axial compliance to account for manufacturing errors, tolerance stack, and the like, and having a passive feature that locks the tool changer in the coupled position when it is removed from a tool stand.

### BACKGROUND

Industrial robots have become an indispensable part of modern manufacturing. Whether transferring semiconductor wafers from one process chamber to another in a cleanroom or cutting and welding steel on the floor of an automobile manufacturing plant, robots perform many manufacturing tasks tirelessly, in hostile environments, and with high precision and repeatability.

In many robotic manufacturing applications, it is cost-effective to utilize a relatively generic robot arm to accomplish a variety of tasks. For example, in an automotive manufacturing application, a robot arm may be utilized to cut, grind, or otherwise shape metal parts during one phase of production, and perform a variety of welding tasks in another. Different welding tool geometries may be advantageously mated to a particular robot arm to perform welding tasks at different locations or in different orientations. In this manner, the considerable cost of an industrial robot may be amortized over a wide range of tools and operations.

In these applications, a tool changer is used to mate different tools to the robot. One half of the tool changer, called the master unit, is permanently affixed to a robot arm. The other half, called the tool unit, is affixed to each tool that the robot may utilize. When the robot arm positions the master unit adjacent to a tool unit connected to a desired tool, a coupling mechanism is actuated that mechanically locks the master and tool units together, thus affixing the tool to the end of the robot arm. The tool changer thus provides a consistent mechanical interface between a robot arm and a variety of robotic tools. A tool changer may also pass utilities to a tool.

A ball-lock configuration is commonly deployed in robotic tool changers as a coupling mechanism. In one such configuration, a plurality of rolling members, such as steel balls, is contained in a collar of the master assembly, which is disposed within a chamber of a tool assembly. The balls are driven radially by a coupling mechanism, and advance to bear against a bearing race in the tool assembly, mechanically coupling the master and tool assemblies together. To decouple, the coupling mechanism allows the balls retreat into the collar as the master assembly separates from the tool assembly. Various configurations, driving mechanisms, and operational aspects of such ball-lock configurations are described in U.S. Pat. Nos. 8,005,570; 8,132,816; 8,209,840; 8,500,132; 8,533,930; 8,601,667; 8,794,418; 9,151,343; 9,724,830; and 10,335,957. All of these patents are assigned to the assignee of the present application, and the disclosures of all of them are incorporated herein by reference in their entireties.

When not in use, each robotic tool is stored in a special rack, or tool holder, within the operative range of the robotic arm. Robot arm controller software “remembers” where each tool is, and each tool is returned to precisely the same position in its tool holder prior to the tool changer decoupling. Similarly, the robot arm controller software “knows” precisely where the next desired tool is stored, and it positions the master unit of the tool changer (on the robot arm) adjacent the tool unit (on the desired tool), then actuates the tool changer to couple the tool to the robot arm.

Safety is a paramount concern in manufacturing environments. A variety of workplace regulations govern the use of large industrial robots, with heavy tools attached thereto. For example, ISO 13849, “Safety of machinery—Safety related parts of control systems,” defines five Performance Levels (PL), denoted A through E. Performance Level D (PLD), mandated for many industrial robotics applications, requires a probability of less than 10⁻⁶ dangerous failures per hour—that is, at least a million hours between dangerous failures.

The most likely dangerous failure, from the perspective of a robotic tool changer and its functionality, is an inadvertent decoupling of the master and tool units, allowing the tool to fall free from the robot arm. This danger has long been recognized, and state-of-the-art robotic tool changer design minimizes the risk. For example, in the event positive coupling power, such as pneumatic pressure, is lost during operation, “failsafe” designs ensure that a tool will not separate from the robot arm. See, e.g., U.S. Pat. Nos. 7,252,453 and 8,005,570, assigned to ATI Industrial Automation, the assignee of the present application.

Mechanically actuated robotic tool changers are specialized devices that enable robots to automatically switch between various end-of-arm tools (EOATs) without human intervention and without the use of auxiliary power sources typically used by powered coupling mechanisms found in typical robotic tool changers, such as electrical, hydraulic, or pneumatic power. Mechanically actuated robotic tool changers typically consist of a master unit attached to the robot arm and a tool unit attached to a robotic tool, with a mechanical coupling mechanism that ensures a secure and precise connection between the master and tool units. This mechanical coupling mechanism may comprise latches, cams, or other mechanical components that engage and disengage the tool to and from the robot arm, allowing for quick and reliable tool changes.

Advantages of mechanically actuated tool changers include increased productivity, enhanced flexibility, cost savings, and improved safety without the use of auxiliary power sources. By reducing downtime associated with manual tool changes, mechanically actuated tool changers boost throughput and efficiency. They also allow a single robot to perform multiple tasks, reducing the need for multiple specialized robots and leading to significant cost savings. Additionally, automated tool changing minimizes human intervention in hazardous environments, enhancing workplace safety.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described and claimed herein, a mechanically actuated robotic tool changer system comprises a master unit configured to attach to a robot, a tool unit configured to attach to a robotic tool, and a tool stand configured to hold the tool unit (and robotic tool). An annular cam ring in the tool unit moves ball members radially in or out—into or out of contact with mating features on the master unit—as the annular cam ring rotates between decoupled and coupled rotary positions. Pinion gear teeth on the circumference of the annular cam ring engage with rack gear teeth on the tool stand, so that linear motion of the tool unit into or out of the tool stand rotates the annular cam ring to couple or decouple the master and tool units. A detent pin locks the annular cam ring in the coupled rotary position when the tool unit is removed from the tool stand. An arm of the tool stand engages an engagement pin to retract the detent pin, unlocking the annular cam ring.

One embodiment relates to a mechanically actuated robotic tool changer system. The system includes a master unit configured to be attached to a robot arm; a tool unit comprising a body and configured to be attached to a robotic tool; and a tool stand configured to securely hold the tool unit when it is decoupled from the master unit. The tool stand is further configured to decouple the master and tool units when the tool unit is positioned in the tool stand, and to couple the master and tool units together when the tool unit is withdrawn from the tool stand. The master unit includes a plurality of ball member accepting recesses. The tool unit includes a plurality of multi-part cam surfaces configured to urge ball members radially inwardly into corresponding ball member accepting recess as the tool unit is moved out of the tool stand, and to allow the ball members to retract into ball member retention surfaces in the multi-part cam surfaces as the tool unit is moved into the tool stand. The annular cam ring further includes pinion gear teeth at least partially around the outer circumference thereof. The tool stand includes a fixed rack having rack gear teeth configured to engage the pinion gear teeth so as to rotate the annular cam ring as the tool unit moves linearly into or out of the tool stand.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a perspective view of a mechanically actuated robotic tool changer system.

FIG. 2 is a perspective view of the opposite side of the master unit than that shown in FIG. 1.

FIG. 3 is an enlarged view of the tool unit disposed in the tool stand.

FIG. 4 is a view of the annular cam ring of the tool unit, showing the multi-part cam surfaces.

FIG. 5A is a section view of the tool unit showing the underside of the annular cam ring in the uncoupled rotary position.

FIG. 5B is a section view of the tool unit showing the underside of the annular cam ring in the coupled rotary position.

FIG. 6 is a perspective view of the coupled master and tool unit just entering (or leaving) the tool stand.

FIG. 7 is a section view of the coupled master and tool units in the position shown in FIG. 6.

FIG. 8 is a perspective view of the tool unit showing operation of the detent mechanism.

FIG. 9 is a section view of the master and tool units coupled together, showing the angled edges and bias springs.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

### Mechanically Actuated Robotic Tool Changer System

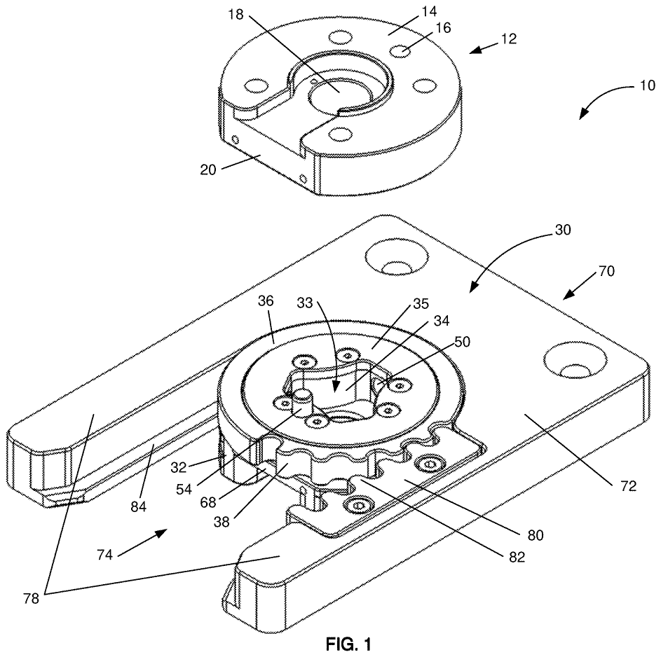

FIG. 1 is a perspective view of a mechanically actuated robotic tool changer system 10 according to aspects of the present disclosure. The mechanically actuated robotic tool changer system 10 comprises a master unit 12, tool unit 30, and tool stand 70. The master unit 12, tool unit 30, and tool stand 70 are configured to act cooperatively and automatically, under motion by an attached robot (not shown), to securely couple the tool unit 30, and hence an attached robotic tool (not shown), to the master unit 12, and hence to the robot, as the tool unit 30 is removed from the tool stand 70. Conversely, following use of the robotic tool, upon the robot moving the tool unit 30 into the tool stand 70, the tool unit 30 is decoupled from the master unit 12, allowing the robot to attach a different tool, and safely storing the robotic tool in the tool stand 70.

The master unit 12, as shown in FIG. 1, includes a body 14, a plurality of mounting holes 16, an optional central bore 18, and an optional utility unit mounting surface 20. The mounting holes 16 provide for attaching the master unit 12 to a robot arm. The optional central bore 18 provides for the passing of cables, pneumatic fluid lines, mechanical linkages, and the like through the master unit 12 and tool unit 30, where such is required or desired. The optional utility unit mounting surface 20 provides a standard mechanical interface to mount a removeable/configurable utility unit (not shown), which mates with a corresponding utility unit (not shown) connected to the tool unit 30. As known in the art, such utility units allow the passage of utilities between a robot and robotic tool when the master and tool units 12, 30 are coupled, and automatically stop the flow of utilities between these entities when the master and tool units 12, 30 are decoupled.

FIG. 2 shows the other side of the master unit 12—i.e., the side facing the tool unit 30 during operation. An inner collar 22 extends from the body 14 and fits within a recess 33 in an outer collar of the tool unit 30, as described below. The bore 18 extends through the collar 22. A plurality of ball member accepting recess 24 are formed in the collar 22. An alignment pin acceptance bore 26 accepts an alignment pin 54 on the tool unit 30 to align the master and tool units 12, 30 upon coupling.

Returning to FIG. 1, the tool unit 30 is shown disposed in the tool stand 70, and hence in the decoupled state. The tool unit 30 includes a body 32, an outer collar 34 defining a central void 33 and having ball retention bores 50, a cap 35 affixed over the outer collar 34, an annular cam ring 36 having pinion gear teeth 38, an alignment pin 54, and optionally a utility unit mounting surface 68. The central void 33 of the outer collar 34 is sized and shaped to accept the inner collar 22 of the master unit 12. The ball retention bores 50 (only one of which is visible in the view of FIG. 1) contain ball members 52 (not shown in FIG. 1), which are used by the tool unit 30 to couple to the master unit 12, as described herein. The alignment pin 54 mates with the alignment pin acceptance bore 26 on the lower surface of the master unit 12 (FIG. 2) to ensure alignment between the master and tool units 12, 30 when they abut and couple. The optional utility unit mounting surface 68 provides a standard mechanical interface to mount a removeable/configurable utility unit (not shown), which mates with a corresponding utility unit (not shown) connected to the master unit 12 on the utility unit mounting surface 20.

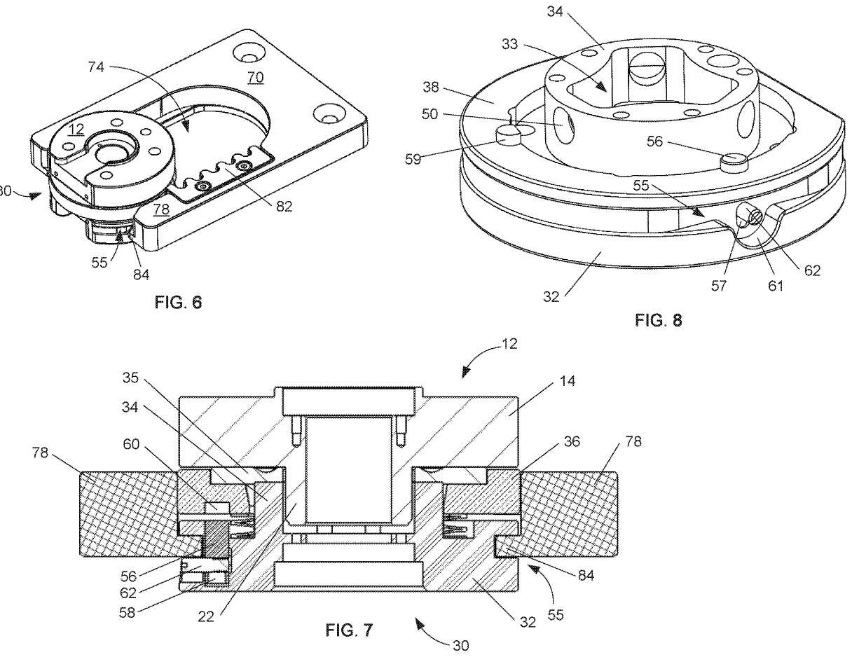

The tool stand 70 comprises a body 72, in which a bay 74 is defined by two arms 78. A ledge 84 on each arm 78 engages a corresponding channel 55 (FIGS. 6-9) in the tool unit body 32. Among other things, the ledges 84 support the weight of the tool unit 30 and robotic tool when the tool unit 30 is disposed in the tool stand 70. A rack 80 disposed along at least one arm 78 includes a plurality of rack gear teeth 82, which are configured to engage with the pinion gear teeth 38 of the annular cam ring 36 of the tool unit 30, as the latter moves into and out of the bay 74 of the tool stand 70.

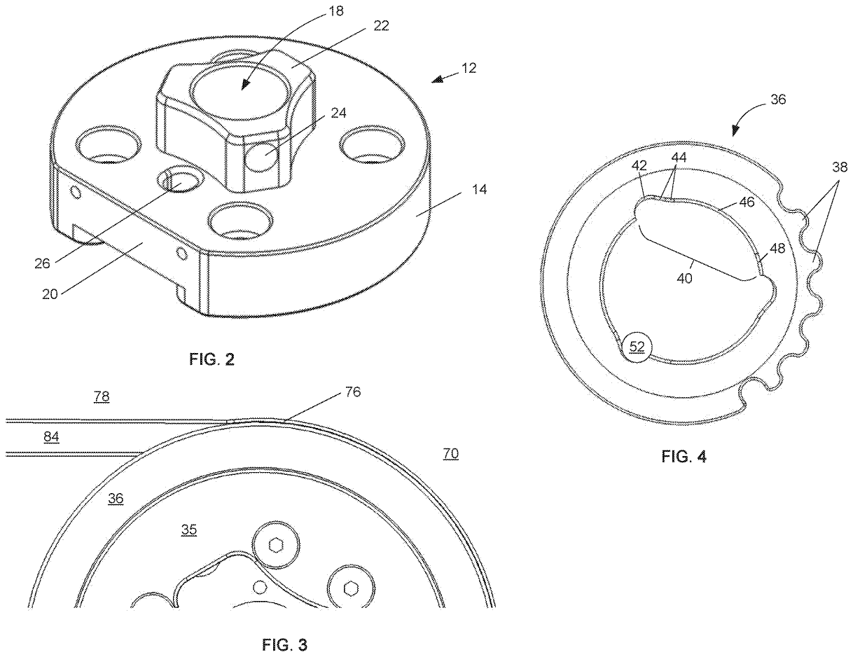

FIG. 3 shows an enlarged view of the tool unit 30 fully inserted into the bay 74 of the tool stand 70. A semicircular detent area 76, which has a diameter slightly wider than the distance between arms 78 of the tool stand 70, provides a positive locking profile between the annular cam ring 36 outer profile and the tool stand 70. The semicircular detent area 76 provides tool retention and prevents movement of the tool unit 30 in the tool stand 70. It also ensures repeatable tool unit 30 location each time the tool unit 30 (and hence attached robotic tool) is picked up and dropped off by the robot.

### Tool Stand Actuated Coupling Mechanism

In the mechanically actuated robotic tool changer system 10, the process of removing a robotic tool from the tool stand 70 securely couples the master unit 12 to the tool unit 30, thus securing the robotic tool to the robot, with the optional provision of utilities if so configured. No external power source is needed, and no power source needs to be continuously supplied to maintain the coupled state. Conversely, the robotic tool is safely decoupled from the robot only by placing the tool unit 30 in the tool stand 70. This decouples the master unit 12 from the tool unit 30, freeing the robot to attach another robotic tool to perform a different task.

In particular, as shown in FIG. 1, the coupling process begins with the robot lowering the master unit 12 over, and into contact with, the tool unit 30 disposed in the tool stand 70. The inner collar 22 of the master unit 12 fits into the central void 33 of the outer collar 34 of the tool unit 30. The alignment pin 54 fits into the alignment pin acceptance bore 26. The central void 33 of the outer collar 34 is clear to accept the inner collar 22, as ball members 52 (FIG. 4) are disposed radially outwardly into ball member retention surfaces 42 in the annular cam ring 36. In one aspect, the inner opening of each ball retention bore 50 in the outer collar 34 of the tool unit 30 has a diameter slightly less than that of the ball members 52, This which allows each ball member 52 to protrude nearly half-way into the central void 33, but retains the ball member 52 between its associated ball retention bore 50 and a surrounding annular cam ring 36 when the master unit 12 is removed. Each ball member 52 is uniquely associated with a respective ball retention bore 50 through all coupling and decoupling operations. That is, the ball members 52 remain in fixed radial positions about the periphery of the outer collar 34, each moving radially inwardly to couple the master and tool units 12, 30, and radially outwardly to decouple them.

Having abutted the master unit 12 to the tool unit 30—with the inner collar 22 disposed in the central void 33 of the outer collar 34—the robot then moves the master unit 12, and hence also the tool unit 30, laterally out of the bay 74 of the tool stand 70. The engagement of pinion gear teeth 38 on the annular cam ring 36 of the tool unit 30 with rack gear teeth 82 on the rack 80 on the tool stand 70 imparts rotary motion to the annular cam ring 36, relative to the tool unit body 32. This rotary motion urges ball members 52 radially inwardly into ball member accepting recess 24 in the inner collar 22, coupling the master and tool units 12, 30 together. This operation is described with reference to the annular cam ring 36, as seen in FIG. 4.

The annular cam ring 36 includes a plurality of pinion gear teeth 38 along at least part of the outer circumference. When moving the tool unit 30 into or out of the tool stand 70, the pinion gear teeth 38 engage with rack gear teeth 82 of a rack 80 disposed in one arm 78 of the tool stand 70 (FIG. 1). As well known in the art, this rack-and-pinion arrangement transforms linear motion of the tool unit 30 into or out of the tool stand 70 into clockwise or counterclockwise rotary motion of the annular cam ring 36, respectively. The annular cam ring 36 is held in the tool unit 30 between the tool unit body 32 and the tool unit cap 35, but is free to rotate, through a predetermined angular range, with respect to the tool unit 30.

In the aspect depicted, the pinion gear teeth 38, and corresponding rack gear teeth 82 are cycloid gears. As known in the art, cycloid gears teeth profiles are based on epicycloids and hypocycloids, which are curves generated by a rolling circle on the outside and inside of another circle, respectively. Cycloid gears provide the advantages of low backlash and high load capacity, and are suitable for high gear ratios. However, the cycloid gear shape teeth are not a limitation of the present disclosure. In other aspects, gear teeth having an involute profile, or a Geneva mechanism, may be used to produce the linear to rotary motion transformation.

The inner surface of the annular cam ring 36 comprises a plurality of multi-part cam surfaces 40. In the aspect depicted, the number of multi-part cam surfaces 40 is three, and each spans approximately 120°. The number three is not a limitation of the present disclosure. In other aspects, the inner surface of the annular cam ring 36 may comprise more or fewer multi-part cam surfaces 40. Each multi-part cam surface 40 includes a ball member retention surface 42, a transition surface 44, a decreasing radius surface 46, and a locking surface 48. Discussion of these surfaces 42-48, for a representative multi-part cam surface 40, proceeds from the decoupled position, when the tool unit 30 is securely disposed in the tool stand 70, to the coupled position, as the robot moves the tool unit 30 out of the tool stand 70, via the master unit 12.

The ball member retention surface 42 is sized and shaped to retain a ball member 52 when the annular cam ring 36 is in the decoupled position, and each ball member retention surface 40 is radially aligned with a corresponding ball retention bore 50 in the outer collar 34 of the tool unit 30. This allows the ball members 52 to extend radially outwardly, to allow the collar 22 of the master unit 12 to move freely into and out of the central void 33 of the outer collar 34. FIG. 4 shows one ball member 52 disposed in a ball retention surface 42 of the annular cam ring 36.

As the tool unit 30 moves out of the tool stand 70, the rack and pinion gears 82, 38 engage, and translate the linear motion of the tool unit 30 (out of the tool stand 70) into rotary motion of the annular cam ring 36 (counterclockwise, as viewed in FIGS. 1, 4). This moves the transition surface 44 into contact with the ball member 52, urging it radially inward, partially through the associated ball retention bore 50 in the outer collar 34.

As the annular cam ring 36 continues to rotate, the decreasing radius surface 46 engages the ball member 52 at its point of maximum radius, measured from the axial center of the tool unit 30 central bore 33. As the annular cam ring 36 continues to rotate, the ball member 52 engages successively smaller radius portions of the decreasing radius surface 46, continuously urging the ball member 52 further and further radially inwardly, and increasing the pressure with which the ball member 52 contacts a ball member accepting recess 24 in the inner collar 22 of the master unit 12.

Finally, as the annular cam ring 36 reaches its maximum extent of rotation, the locking surface 48 engages the ball member 52, pressing it firmly radially inward into the ball member accepting recess 24. In one aspect, the locking surface 48 additionally serves as a “fail-safe” surface. It is cylindrical, with no change in radius across its extent. Accordingly, the reaction force of the ball member 52, seated in its ball member accepting recess 24, is normal to the locking surface 48. As such, there is no component of the reaction force that is directed in a tangential direction, which would tend to urge the annular cam ring 36 to rotate in the unlocking direction (clockwise, as depicted in FIGS. 1, 4).

Once the robot has moved the master unit 12, and hence the tool unit 30 and attached robotic tool, to the point of maximum rotation of the annular cam ring 36, the master unit 12 and tool unit 30 are firmly coupled together, and the coupled assembly, including a robotic tool attached to the tool unit 30, may safely exit the tool stand 70. The master unit 12 and tool unit 30 may not decouple until the robot moves the tool unit 30 back into the tool stand 70. When this occurs, the rack gear teeth 82 again engage the pinion gear teeth 38, rotating the annular cam ring 36 with respect to the tool unit body 32, in the opposite direction (clockwise, as depicted in FIGS. 1, 4). The above-described sequence of contacts between surfaces of each multi-part cam surface 40 and corresponding ball member 52 occurs in the reverse order, resulting in the ball members 52 residing in the retention surfaces 42, releasing contact with the inner collar 22 and allowing the master unit 12 to move away (upwardly as depicted in FIG. 1), leaving the tool unit 30 and attached robotic tool safely disposed in the tool stand 70.

### Detent Mechanism and Fail-safe Coupling

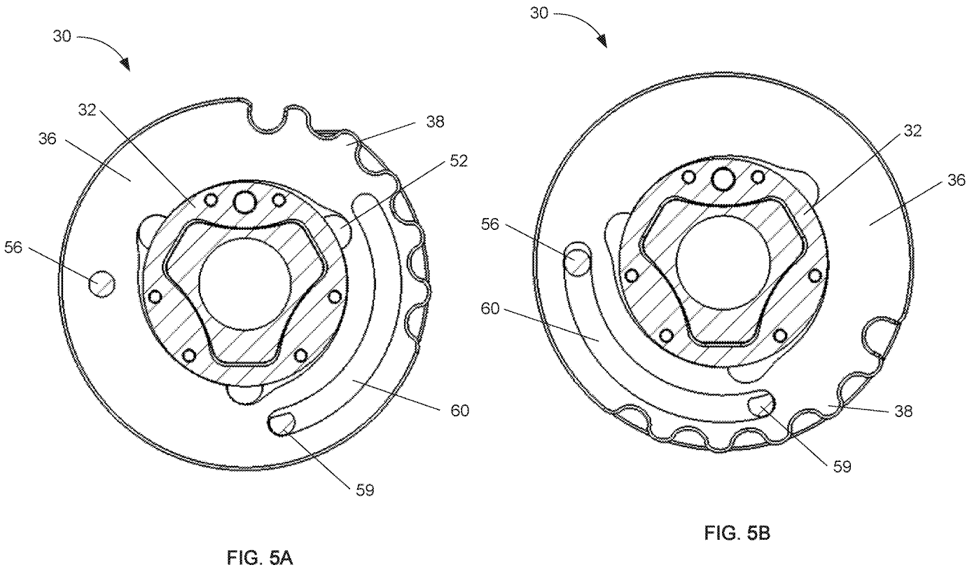

According to one aspect of the present disclosure, even greater safety is achieved by a detent mechanism that both limits the extent of rotation of the annular cam ring 36, and locks the annular cam ring 36 in the fully coupled rotary position when the tool unit 30 is withdrawn from the tool stand 70. The detent mechanism is described with reference to FIGS. 5A, 5B, 6, 7, and 8. Note that FIGS. 5A and 5B are section views taken below the annular cam ring 36 and looking “up” towards the master unit 12, hence the rotation directions are opposite to those described with respect to FIGS. 1 and 4.

FIG. 5A is a section view showing the tool unit 30 in the decoupled position, such as when it is disposed in the tool stand 70. The annular cam ring 36 has been rotated, by engagement of the pinion gear teeth 38 with rack gear teeth 82 on the tool stand 70, to the fully decoupled position. The ball members 52 are each retracted radially outward, and nestled in the ball member retention surface 42 of the respective multi-part cam surface 40. A fixed pin 59 is attached to the tool unit body 32, and extends into an arcuate detent groove 60 formed on the side of the annular cam ring 36 that faces the tool unit body 32 (i.e., the opposite side of the annular cam ring 36 than that depicted in FIG. 1). As shown, the detent groove 60 is limited in its angular extent along the annular cam ring 36. The fixed pin 59 in the detent groove 60 limits the rotation of the annular cam ring 36 in the decoupling direction (counterclockwise as depicted in FIG. 5A) to the fully decoupled rotary position. A detent pin 56, as best seen in FIG. 7, is retracted, against the bias of a detent spring 58.

FIG. 5B is a section view showing the tool unit 30 in the coupled rotary position, such as when it is has coupled to the master unit 12 and has been removed from the tool stand 70. The ball members 52 are not visible, as they are all moved radially inward to engage in respective ball member accepting recess 24 in the inner collar 22 of the master unit 12. The ball members 52 are held in this position by the locking surfaces 48 of the multi-part cam surfaces 40. The fixed pin 59 now engages the opposite end of the detent slot 60, limiting the rotation of the annular cam ring 36 in the coupling direction (clockwise as depicted in FIGS. 5A-B) to the fully coupled rotary position. The detent pin 56, under bias of the detent spring 58, now extends into the detent groove 60, and prevents any rotation of the annular cam ring 36 in the decoupling direction (counterclockwise as depicted in FIG. 5B). In this manner, the detent pin 56 and detent groove 60 positively lock the annular cam ring 36 in the coupled rotary position. As explained below, the detent pin 56 can only be extracted from the detent groove 60 by action of an engagement pin 62, which is only engaged by an arm 78 of the tool stand 70.

FIG. 6 shows the tool unit 30 just entering (or leaving) the bay 74 of the tool stand 70. In this position, the master and tool units 12, 30 are fully coupled together, as the rack gear teeth 82 have not engaged (or have disengaged) the pinion gear teeth 38. However, the ledges 84 of the arms 78 of the tool stand 70 have entered (or have not exited) the channels 55 of the tool unit body 32.

FIG. 7 is a section view of the master unit 12, tool unit 30, and tool stand 70, in the position shown in FIG. 6. As mentioned, and as shown on the right side of FIG. 7, the ledges 84 of the arms 78 of the tool stand 70 engage in the channel 55 in the tool unit body 32. As shown on the left side of FIG. 7, the detent pin 56 is biased towards engagement in the detent groove 60 (up, as depicted in FIG. 7) by a detent spring 58. Interposed between the detent spring 58 and detent pin 56 is an engagement pin 62. The engagement pin 62 is engaged by the ledge 84 of one arm 78 of the tool stand 70, which urges the engagement pin 62 (and hence the detent pin 56) downwardly, against the bias of the detent spring 58.

If the tool unit 30 is being moved into the bay 74 of the tool stand 70, this action of the engagement pin 62 extracts the detent pin 56 from the detent groove 60, allowing the annular cam ring 36 to rotate towards the decouple rotary position. Alternatively, as the tool unit 30 is being extracted from the tool stand 70, as the ledge 84 of the arm 78 of the tool stand 70 withdraws from the channel 55 in the tool unit body 32, the engagement pin 62 allows the detent pin 56 to move, under bias of the detent spring 58, into the detent groove 60, thus locking the annular cam ring 36 in the coupled rotary position.

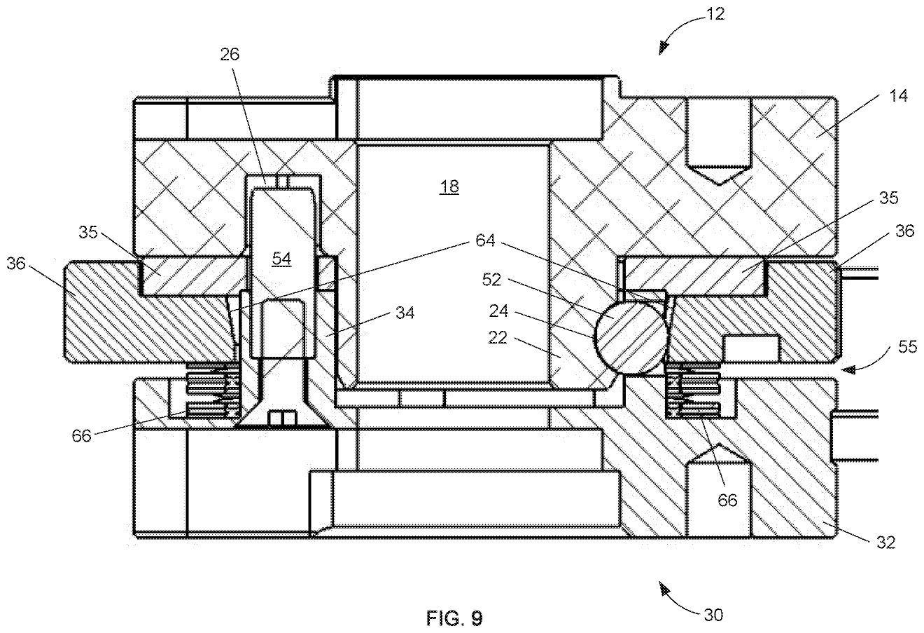

FIG. 8 is a perspective view of the tool unit body 32 (without the cap 35 or annular cam ring 36), showing operation of the engagement pin 62 and detent pin 56. In FIG. 8, the tool unit 30 is not disposed in the tool stand 70, and is hence is the coupled state. The detent pin 56 extends up from the tool unit body 32 and into the detent groove 60 of the locking ring 36 (not shown), locking the annular cam ring 36 against any rotation in the decouple direction (clockwise, as shown in FIG. 8). FIG. 8 shows the engagement pin 62 extending into the channel 55 in the tool unit body 32, through a slot 57. A dip 61 formed in the lower edge of the channel 55 allows the engagement pin 62 to be lowered, against the bias of the detent spring 58 (not shown), by action of the ledge 84 of one arm 78 of the tool stand 70 (not shown), as the tool unit 30 enters the bay 74 of the tool stand 70. By utilizing the ledge 84 of the arm 78 of the tool stand 70 to contact the engagement pin 62 and extract the detent pin 56 from the channel 60, it is ensured that the annular cam ring 36 is never able to rotate in the decouple direction until the tool unit 30 is disposed in the tool stand 70. The eliminates any possibility of the tool unit 30 coming decoupled from the master unit 12 prior to the tool unit 30 (and hence attached robotic tool) being disposed in, and supported by, the tool stand 70.

### Compliance and Tolerance/Wear Compensation

According to one aspect of the present disclosure, the coupling action between the master and tool units 12, 30 is further enhanced, providing some compliance motion and protecting from the deleterious effects of manufacturing defects, tolerance stacking, and the like, by an angled contact edge on at least the locking surface 48 of the annular cam ring 36, and a bias source. FIG. 9 shows a section view of the master unit 12 and tool unit 30 coupled together. The inner collar 22 of the master unit 12 is disposed in the central void 33 of the outer collar 34 of the tool unit 30. The alignment pin 54 on the tool unit 30 is disposed in the alignment bore 26 in the master unit 12. The annular cam ring 36 is rotated to the fully coupled rotary position, whereby locking surfaces 48 of the multi-part cam surfaces 40 engage the ball members 52 and press them firmly into corresponding ball member accepting recess 24 in the inner collar 22 of the master unit 12.

The locking surfaces 48 each have an angled edge 64. The angle is in a direction radially outward, moving in a direction towards the master unit 12 (up, as depicted in FIG. 9). The multi-part cam surfaces 40 (including the locking surfaces 48) are on a portion of the annular cam ring 36 that is thinner than the space between the tool unit body 32 and the overlying cap 35, allowing the annular cam ring 36 to move slightly in an axial direction. Bias springs 66 press the annular cam ring 36 axially towards the master unit 12 (up, as depicted in FIG. 9). This bias, and the angled edge 64, press the ball members 52 firmly into corresponding ball member accepting recess 24 when the annular cam ring 36 rotates to the coupled position—even if wear, tolerances, and the like result in one or more locking surfaces 48 not pressing the ball members 52 with the desired/designed level of force. Additionally, in the event of an overload condition, the annular cam ring 36 is driven against the bias springs 66 until the annular cam ring 36 rests against the tool unit body 32. This provides a slight degree of compliance motion, and prevents further separation of the master unit 12 and tool unit 30.

In some aspects, only the locking surfaces 48 of each multi-part cam surface 40 includes an angled edge 64; in other aspects, the entire inner edge of the annular cam ring 36 may have angled edges 64. In one aspect, the angled edge has an angle of 10°, although this is not a limitation of the present disclosure. Other aspects may include angled edges having lesser or greater angles.

### Advantages and Technical Effects

Aspects of the present disclosure present significant advantages over the prior art, and may achieve one or more of the following technical effects. Coupling the master unit 12 and tool unit 30 together by using the tool stand 70 to rotate the annular cam ring 36 allows for the generation of significant coupling force on the ball members 52 without the application of a large actuation force, through the development of mechanical advantage. This lower actuation force over a longer distance is advantageous for humanoids and collaborative robots (COBOT) that have limited strength compared to industrial robots. The angled edge 64 on the inner edge of the annular cam ring 36, and a bias springs 66 to bias the annular cam ring 36, maintains a coupling force on the ball members 52 in the event of manufacturing errors or long-term wear. Actuating the annular cam ring 36 by the engagement of rack gear teeth 82 on the tool stand 70 results in an inherently safe coupling mechanism—the annular cam ring 36 cannot be rotated unless and until the tool unit 30 is disposed in the tool stand. Yet further safety is achieved by engagement of the detent pin 56 in the detent channel 60 to lock the annular cam ring 36 in the fully coupled rotary position. Because the detent pin 56 is only removed from the detent channel 60 by action of the tool stand ledge 84 against the engagement pin 62, the annular cam ring 36 can only be rotated towards the decouple rotary position when the tool unit 30 is disposed in the tool stand 70. Although not a limitation of the disclosure, the use of a cycloidal gear profile between the rack gear teeth 82 and pinion gear teeth 38 on the annular cam ring 36, instead of, e.g., an involute profile, allows for easier manufacture of the gear teeth 82, 38. The cycloidal gear profile has the added benefit of being more ergonomic in the event a human manually rotates the annular cam ring 36 (after depressing the engagement pin 62). The mechanically actuated robotic tool changer system 10 thus presents the significant advantages of enhanced safety, fail-safe operation, robustness to tolerances and wear, and positive retention and precise location of the tool unit 30 in the tool stand 70.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the aspects disclosed herein may be applied to any other aspect, wherever appropriate. Likewise, any advantage of any of the aspects may apply to any other aspects, and vice versa. Other objectives, features, and advantages of the enclosed aspects will be apparent from the description. As used herein, the term “configured to” means set up, organized, adapted, or arranged to operate in a particular way; the term is synonymous with “designed to.”

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A mechanically actuated robotic tool changer system, comprising:
a master unit configured to be attached to a robot arm;
a tool unit comprising a body and configured to be attached to a robotic tool; and
a tool stand configured to securely hold the tool unit when it is decoupled from the master unit, and further configured to decouple the master and tool units when the tool unit is positioned in the tool stand, and to couple the master and tool units together when the tool unit is withdrawn from the tool stand;
wherein
the master unit includes a plurality of ball member accepting recesses;
the tool unit comprises an annular cam ring configured to rotate about the tool unit body as the tool unit is moved into or out of the tool stand, the annular cam ring including a plurality of multi-part cam surfaces configured to urge ball members radially inwardly into corresponding ball member accepting recess as the tool unit is moved out of the tool stand, and to allow the ball members to retract into ball member retention surfaces in the multi-part cam surfaces as the tool unit is moved into the tool stand, the annular cam ring further including pinion gear teeth at least partially around the outer circumference thereof; and
the tool stand comprising a fixed rack having rack gear teeth configured to engage the pinion gear teeth so as to rotate the annular cam ring as the tool unit moves linearly into or out of the tool stand.

2. The system of claim 1, wherein the ball member accepting recesses are formed in an inner collar of the master unit, that is configured to fit within a central void in an outer collar of the tool unit.

3. The system of claim 2, wherein the ball members extend partially through bores in the outer collar sufficiently to fit into the ball member accepting recess, but the bores retain the ball members between the outer collar and the annular cam ring when the master and tool units are decoupled.

4. The system of claim 1 wherein each multi-part cam surface comprises:
a ball member retention surface configured to retain a ball member when the master and tool units are decoupled;
a transition surface abutting the ball member retention surface and configured to urge a ball member radially inward as the annular cam ring rotates in a coupling direction;
a decreasing radius surface abutting the transition surface and having a successively decreasing radius and configured to successively urge a ball member into a corresponding ball member accepting recess as the annular cam ring rotates in a coupling direction; and
a locking surface abutting the decreasing radius surface and configured to press a ball member into a corresponding ball member accepting recess with a predetermined force when the annular cam ring rotates to a coupled rotary position.

5. The system of claim 4 wherein the locking surface is cylindrical such that all reactive force exerted by the ball member on the locking surface is normal to the locking surface and has no tangential force component urging the annular cam ring to rotate in a decoupling direction.

6. The system of claim 1 wherein a fixed pin on the tool unit body engages an arcuate detent groove in the annular cam ring to limit rotation of the annular cam ring between decoupled and coupled rotary positions.

7. The system of claim 6 wherein a detent pin engages the detent groove to lock the annular cam ring in the coupled rotary position when the tool unit is not disposed in the tool stand.

8. The system of claim 6 wherein the detent pin is extracted from the detent groove, thus unlocking the annular cam ring and allowing it to rotate towards the decoupled rotary position, by an arm of the tool unit engaging an engagement pin connected to the detent pin.

9. The system of claim 1 wherein at least the locking surfaces of the annular cam ring include an angled edge in the radial direction, and wherein bias springs urge the angled edge of the annular cam ring against ball members when the master and tool units are coupled together, whereby the angled edge under the force of bias springs provides compliance and maintains force on the ball members in the case of manufacturing defects, tolerance stack, or wear.
